(19) United States
(12) Patent Application Publication
(10) Pub. No.: US 2023/0390866 A1
(43) Pub. Date: Dec. 7, 2023

(54) OPTICAL RELAY SYSTEM AND METHODS OF USE AND MANUFACTURE

(71) Applicant: ELECTRO SCIENTIFIC INDUSTRIES, INC., Beaverton, OR (US)

(72) Inventors: James BROOKHYSER, Beaverton, OR (US); Jan KLEINERT, Beaverton, OR (US); Jered RICHTER, Beaverton, OR (US); Mark UNRATH, Beaverton, OR (US)

(73) Assignee: ELECTRO SCIENTIFIC INDUSTRIES, INC., Beaverton, OR (US)

(21) Appl. No.: 18/252,059

(22) PCT Filed: Nov. 23, 2021
(86) PCT No.: PCT/US2021/060478

§ 371 Date: May 8, 2023

Related U.S. Application Data
(60) Provisional application No. 63/122,573, filed on Dec. 8, 2020.

(51) Int. Cl. B23K 26/082; B23K 26/06

(52) U.S. Cl. CPC B23K 26/0821; B23K 26/0648; B23K 26/0676; B23K 26/0643; B23K 26/0665

(57) ABSTRACT

Numerous embodiments of optical relay systems are disclosed. In one embodiment, a laser-processing apparatus includes an optical relay system configured to correct for beam placement errors by maintaining the optical path length of a beam of laser energy between a first positioner and a scan lens. In another embodiment, the optical relay system may include a first lens, a second lens, and a zoom lens assembly arranged between the first lens and the second lens, wherein the zoom lens assembly includes a first lens group and a second lens group. The zoom lens assembly may be movable relative to the first lens and the second lens (e.g., mounted on a positioner, such as a motion stage). The distance between the lenses of the first lens group and the distance between the lenses of the second lens group may be fixed or variable.

### CROSS-REFERENCE TO RELATED APPLICATIONS

This application claims the benefit of U.S. Provisional Application No. 63/122,573, filed Dec. 8, 2020, the contents of which are incorporated by reference in its entirety.

### TECHNICAL FIELD

Embodiments described herein relate generally to laser-processing apparatuses, optical relay systems, the components thereof, and to techniques for operating the same.

### BACKGROUND

Laser-processing systems or apparatus are used in a wide variety of applications, including printed circuit board (PCB) machining, additive manufacturing, and the like. Many laser-processing systems include a scan lens for focusing a beam of laser energy onto a workpiece and a positioner for moving the focused beam of laser energy relative to some material to be processed. In some laser-processing systems, the scan lens can be moved while the positioner remains stationary, so the optical path length between the scan lens and the positioner can change depending on the movement of the scan lens. A change in the optical path length can result in the beam of laser energy rotating about a pivot point that is located outside the entrance pupil of the scan lens (also referred to herein as the “scan lens entrance pupil” or, more simply, the “SLEP”). Location of the pivot point outside the SLEP can introduce telecentric errors, create beam distortion at the workpiece, and result in undesirable beam clipping at the scan lens entrance pupil.

### SUMMARY

One embodiment of the present invention can be characterized as a laser processing apparatus that includes: a first positioner configured to deflect a beam of laser energy about a pivot point, a scan lens movable relative to the first positioner, and an optical relay system configured to relay the pivot point to the scan lens in correspondence with movement of the scan lens, wherein the scan lens is movable relative to the optical relay system. The first positioner may be provided as an AOD system or a galvanometer mirror system. The optical relay system may be movable relative to the scan lens and/or the first positioner. The optical relay system may include an optical input, a first reflector having a first reflective surface, wherein the first reflector is arranged to receive the beam of laser energy propagating from the first positioner; an optical output; and a second reflector having a second reflective surface opposing the first reflective surface, wherein the first and second reflective surfaces are arranged and configured to relay the beam of laser energy received at the first reflector from the optical input to the optical output. The first reflective surface and the second reflective surface may be substantially parallel to one another. A first lens may be mounted at the optical input; and a second lens may be mounted at the optical output. The first positioner (e.g., an AOD system and a galvanometer mirror system) may be movable relative to the optical relay system, and a linear motion stage may be coupled to the first positioner, with the stage being operative to change the position of the first positioner relative to the optical relay system.

In another embodiment, the optical relay system may include a first lens arranged and configured to focus the beam of laser energy within the optical relay system, and a second lens arranged and configured to focus the beam of laser energy exiting the optical relay system, wherein the first lens and the second lens are configured to magnify the beam of laser energy. The first lens may be configured to focus the beam of laser energy at a point that is separated from the first reflective surface and the second reflective surface. A stage may be coupled to the optical relay system, wherein the stage is operative change the position of the optical relay system relative to the scan lens, the first positioner, or a combination thereof.

In another embodiment, the laser processing apparatus may further comprise a second positioner arranged between the optical relay system and the scan lens, wherein the second positioner may be a galvanometer, an AOD system, a fast steering mirror, or a rotating polygon mirror.

In another embodiment, the optical relay system may include a first lens, a second lens, and a zoom lens assembly arranged between the first lens and the second lens, wherein the zoom lens assembly includes a first lens group and a second lens group, and wherein each of the first lens group and the second lens group includes a plurality of lenses. The first lens group and the second lens group may be provided as telephoto doublets arranged symmetrically with respect to a transverse centerline of the zoom lens assembly. The zoom lens assembly may be movable relative to at least one of the first lens and the second lens (e.g., mounted on a first positioner, such as a motion stage). The first lens and the second lens may provided as positive lenses, planar-convex lenses, bi-convex lenses, or positive meniscus lenses or any combination thereof. The distance between the lenses of the first lens group and the distance between the lenses of the second lens group may be fixed or variable. The first lens group may be mounted on a second positioner (e.g., a motion stage) configured to adjust the distance between the lenses of the first lens group. The second lens group may be mounted on a third positioner (e.g., a motion stage) configured to adjust the distance between the lenses of the second lens group.

### BRIEF DESCRIPTION OF THE DRAWINGS

FIGS. 1 to 3 are schematic views illustrating various spatial states of a laser-processing system.

FIG. 4 schematically illustrates a laser-processing apparatus according to one embodiment.

FIGS. 5 and 6 show different positional states of an optical relay system according to one embodiment.

FIGS. 7A and 7B show different positional states of another embodiment of an optical relay system. In FIGS. 7A and 7B, the optical relay system is shown in a cross-sectional elevation view.

FIGS. 8 and 9 show different positional states of another embodiment of an optical relay system.

FIGS. 10 and 11 show different positional states of another embodiment of an optical relay system.

FIG. 12 shows a view of another embodiment of an optical relay system.

FIGS. 13A-13C show different positional states of the embodiment of the optical relay system shown in FIG. 12.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The section headings used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. OVERVIEW

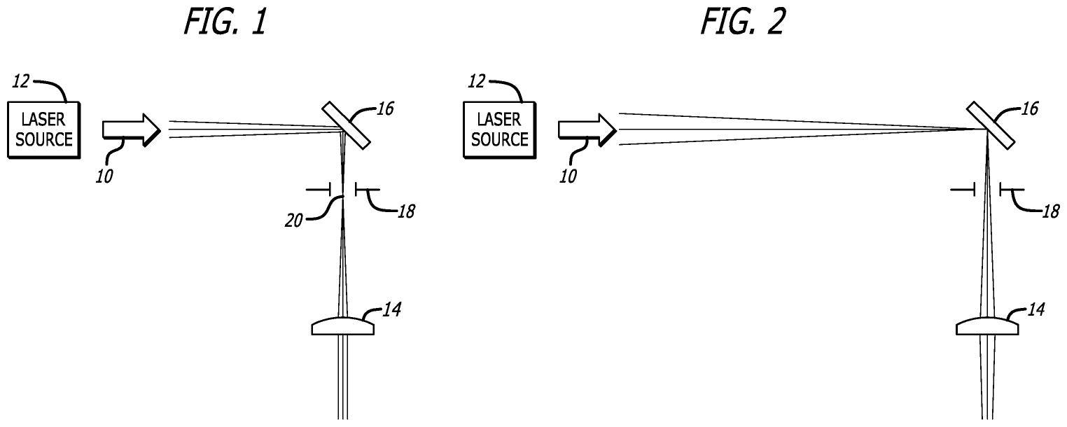

FIGS. 1 to 3 are schematic views illustrating various spatial states of a laser-processing system. Referring to FIG. 1, a beam of laser energy 10 has been deflected by a positioner 12 and propagates toward a scan lens 14 via a fold mirror 16. Although not illustrated, relay optics are typically included to relay the pivot point of the positioner 12 to the entrance pupil 18 of the scan lens 14. As shown, the image of the beam from the positioner 12 pivots about a virtual pivot point 20 at the entrance pupil 18 of the scan lens 14, thereby resulting in acceptable telecentricity of the rays exiting the scan lens 14.

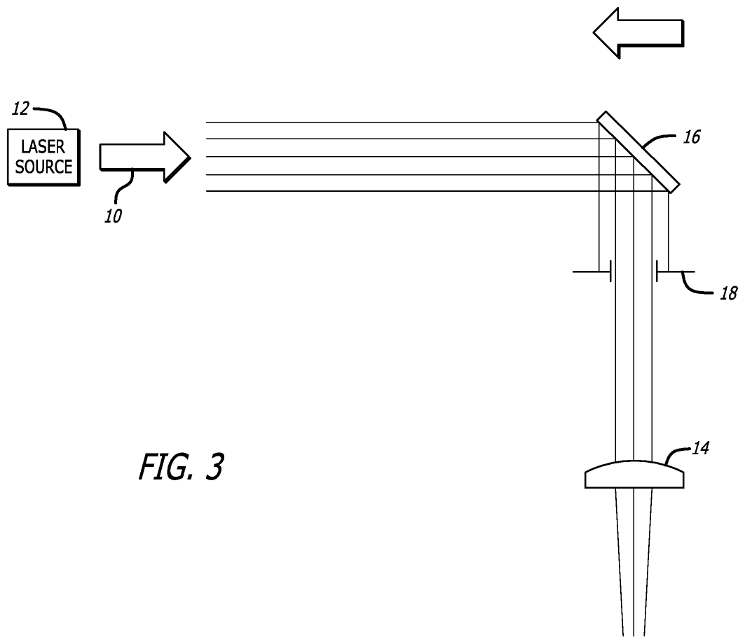

Referring to FIG. 2, the scan lens 14 and fold mirror 16 shown in FIG. 1 have been moved away from the positioner 12, thereby increasing the optical path length between the positioner 12 and the scan lens 14. Lengthening the optical path length results in moving the virtual pivot point 20 away from the entrance pupil 18 and the scan lens 14 (e.g., at or near the surface of the fold mirror 16, in this case). Such movement of the virtual pivot point 20 away from the scan lens 14 results in poor telecentricity of the rays exiting the scan lens 14, which can cause, among other problems, positional errors in spot location at the workpiece.

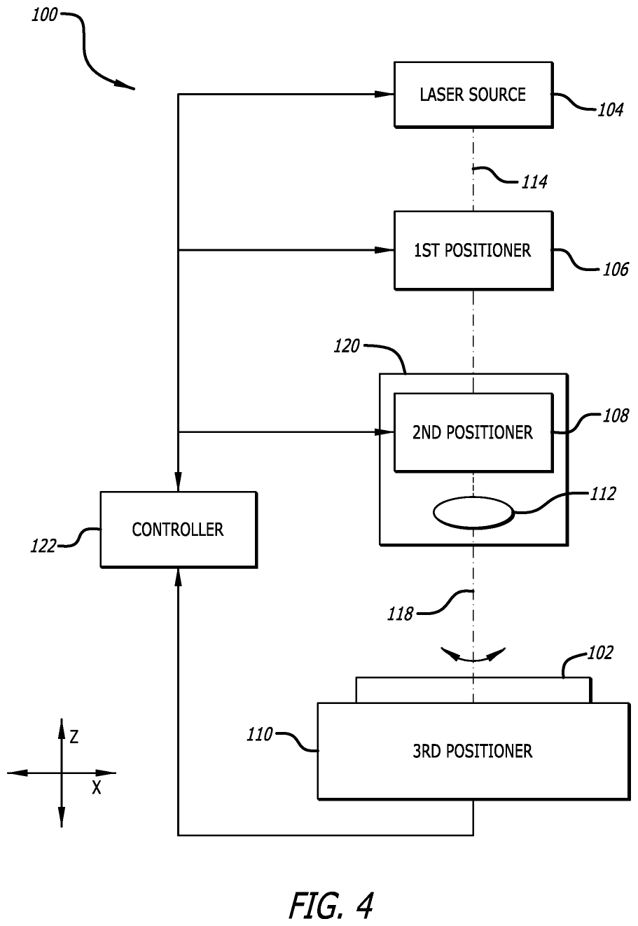

Referring to FIG. 3, the scan lens 14 and fold mirror 16 shown in FIG. 1 have been moved toward the positioner 12, thereby decreasing the optical path length between the positioner 12 and the scan lens 14. Shortening the optical path length results in moving the virtual pivot point 20 away from the entrance pupil 18 and toward the scan lens 14 (and even beyond the scan lens 14, in this case). Such movement of the virtual pivot point 20 toward the scan lens 14 results in poor telecentricity, which can cause positional errors in spot location at the workpiece, as discussed above. Such movement of the virtual pivot point 20 can also result in undesirable beam clipping by the entrance pupil 18, thus reducing the useful deflection range of the positioner 12.

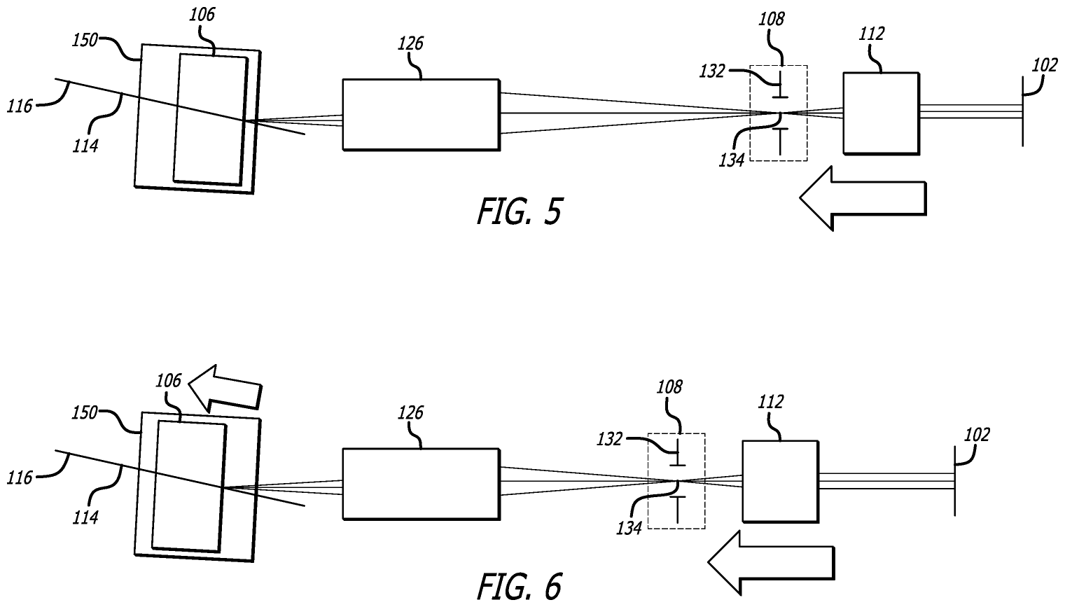

FIG. 4 schematically illustrates a laser-processing apparatus in accordance with one embodiment of the present invention.

Referring to the embodiment shown in FIG. 4, a laser-processing apparatus 100 (also referred to herein simply as an “apparatus”) for processing a workpiece 102 can be characterized as including a laser source 104 for generating a beam of laser energy, one or more positioners (e.g., a first positioner 106, a second positioner 108, a third positioner 110, or any combination thereof) and a scan lens 112. The scan lens 112 and the second positioner 108 may be integrated into a scan head 120, described in further detail below.

Laser energy transmitted along a beam path 114, through the scan lens 112, propagates along a beam axis 118 so as to be delivered to the workpiece 102. Laser energy propagating along the beam axis 118 may be characterized as having a Gaussian-type spatial intensity profile or a non-Gaussian-type (i.e., “shaped”) spatial intensity profile (e.g., a “top-hat” spatial intensity profile). Regardless of the type of spatial intensity profile, the spatial intensity profile can also be characterized as a shape (i.e., a cross-sectional shape, also referred to herein as a “spot shape”) of the beam of laser energy propagating along the beam axis 118 (or beam path 114), which may be circular, elliptical, square, rectangular, triangular, hexagonal, ring-shaped, etc., or arbitrarily shaped. As used herein, the term “spot size” refers to the diameter or maximum spatial width of the beam of laser energy delivered at a location (also referred to as a “process spot,” “spot location” or, more simply, a “spot”) where the beam axis 118 intersects a region of the workpiece 102 that is to be, at least partially, processed by the delivered beam of laser energy. For purposes of discussion herein, spot size is measured as a radial or transverse distance from the beam axis 118 to where the optical intensity drops to, at least, 1/e² of the optical intensity at the beam axis 118. Generally, the spot size of the beam of laser energy will be at a minimum at the beam waist. Once delivered to the workpiece 102, laser energy within the beam can be characterized as impinging the workpiece 102 at a spot size in a range from 2 μm to 200 μm. It will be appreciated, however, that the spot size can be made smaller than 2 μm or larger than 200 μm. Thus, the beam of laser energy delivered to the workpiece 102 can have a spot size greater than, less than, or equal to 2 μm, 3 μm, 5 μm, 7 μm, 10 μm, 15 μm, 30 μm, 35 μm, 40 μm, 45 μm, 50 μm, 55 μm, 80 μm, 100 μm, 150 μm, 200 μm, etc., or between any of these values.

Generally, the aforementioned positioners (e.g., the first positioner 106, the second positioner 108 and the third positioner 110 are configured to change the relative position between the spot and the workpiece 102. In view of the description that follows, it should be recognized that inclusion of the second positioner 108 is optional, provided that the apparatus 100 includes the first positioner 106 and, optionally, the third positioner 110. Likewise, it should be recognized that inclusion of the third positioner 110 is optional, provided that the apparatus 100 includes the first positioner 106 and, optionally, the second positioner 108.

The apparatus 100 may also include one or more other optical components (e.g., beam traps, beam expanders, beam shapers, beam splitters, apertures, filters, collimators, lenses, mirrors, prisms, polarizers, phase retarders, diffractive optical elements (commonly known in the art as DOEs), refractive optical elements (commonly known in the art as ROEs), or the like or any combination thereof) to focus, expand, collimate, shape, polarize, filter, split, combine, crop, absorb, or otherwise modify, condition, direct, etc., the beam of laser energy as it propagates along beam path 114. To the extent that optical components such as beam expanders, lenses, beam splitters, prisms, dichroic filters, windows, waveplates, DOEs, ROEs, etc., are formed of bulk transparent materials (which may, optionally, be coated one or more anti-reflection coatings, or the like) intended to transmit an incident beam of laser energy, such optical components are generically referred to herein as “transmissive optical components.” As used herein, the collection of positioners and other optical components can, when assembled together into the laser-processing apparatus 100, be considered to constitute a “beam path assembly.”

### A. Laser Source

In one embodiment, the laser source 104 is operative to generate laser pulses. As such, the laser source 104 may include a pulse laser source, a CW laser source, a QCW laser source, a burst mode laser, or the like or any combination thereof. In the event that the laser source 104 includes a QCW or CW laser source, the laser source 104 may be operated in a pulsed mode, or may be operated in a non-pulsed mode but further include a pulse gating unit (e.g., an acousto-optic (AO) modulator (AOM), a beam chopper, etc.) to temporally modulate beam of laser radiation output from the QCW or CW laser source. Although not illustrated, the apparatus 100 may optionally include one or more harmonic generation crystals (also known as “wavelength conversion crystals”) configured to convert a wavelength of light output by the laser source 104. In another embodiment, however, the laser source 104 may be provided as a QCW laser source or a CW laser source and not include a pulse gating unit. Thus, the laser source 104 can be broadly characterized as operative to generate a beam of laser energy, which may manifested as a series of laser pulses or as a continuous or quasi-continuous laser beam, which can thereafter be propagated along the beam path 114. Although many embodiments discussed herein make reference to laser pulses, it should be recognized that continuous or quasi-continuous beams may alternatively, or additionally, be employed whenever appropriate or desired.

Laser energy output by the laser source 104 can have one or more wavelengths in the ultraviolet (UV), visible or infrared (IR) range of the electromagnetic spectrum. Laser energy in the UV range of the electromagnetic spectrum may have one or more wavelengths in a range from 10 nm (or thereabout) to 385 nm (or thereabout), such as 100 nm, 121 nm, 124 nm, 157 nm, 200 nm, 334 nm, 337 nm, 351 nm, 380 nm, etc., or between any of these values. Laser energy in the visible, green range of the electromagnetic spectrum may have one or more wavelengths in a range from 500 nm (or thereabout) to 560 nm (or thereabout), such as 511 nm, 515 nm, 530 nm, 532 nm, 543 nm, 568 nm, etc., or between any of these values. Laser energy in the IR range of the electromagnetic spectrum may have one or more wavelengths in a range from 750 nm (or thereabout) to 15 μm (or thereabout), such as 600 nm to 1000 nm, 752.5 nm, 780 nm to 1060 nm, 799.3 nm, 980 nm, 1047 nm, 1053 nm, 1060 nm, 1064 nm, 1080 nm, 1090 nm, 1152 nm, 1150 nm to 1350 nm, 1540 nm, 2.6 μm to 4 μm, 4.8 μm to 8.3 μm, 9.4 μm, 10.6 μm, etc., or between any of these values.

When the beam of laser energy is manifested as a series of laser pulses, the laser pulses output by the laser source 104 can have a pulse width or pulse duration (i.e., based on the full-width at half-maximum (FWHM) of the optical power in the pulse versus time) that is in a range from 10 fs to 900 ms. It will be appreciated, however, that the pulse duration can be made smaller than 10 fs or larger than 900 ms. Thus, at least one laser pulse output by the laser source 104 can have a pulse duration less than, greater than or equal to 10 fs, 15 fs, 30 fs, 50 fs, 100 fs, 150 fs, 200 fs, 300 fs, 500 fs, 600 fs, 750 fs, 800 fs, 850 fs, 900 fs, 950 fs, 1 ps, 2 ps, 3 ps, 4 ps, 5 ps, 7 ps, 10 ps, 15 ps, 25 ps, 50 ps, 75 ps, 100 ps, 200 ps, 500 ps, 1 ns, 1.5 ns, 2 ns, 5 ns, 10 ns, 20 ns, 50 ns, 100 ns, 200 ns, 400 ns, 800 ns, 1000 ns, 2 μs, 5 μs, 10 μs, 15 μs, 20 μs, 25 μs, 30 μs, 40 μs, 50 μs, 100 μs, 300 μs, 500 μs, 900 μs, 1 ms, 2 ms, 5 ms, 10 ms, 20 ms, 50 ms, 100 ms, 300 ms, 500 ms, 900 ms, 1 s, etc., or between any of these values.

Laser pulses output by the laser source 104 can have an average power in a range from 5 mW to 50 kW. It will be appreciated, however, that the average power can be made smaller than 5 mW or larger than 50 kW. Thus, laser pulses output by the laser source 104 can have an average power less than, greater than or equal to 5 mW, 10 mW, 15 mW, 20 mW, 25 mW, 50 mW, 75 mW, 100 mW, 300 mW, 500 mW, 800 mW, 1 W, 2 W, 3 W, 4 W, 5 W, 6 W, 7 W, 10 W, 15 W, 18 W, 25 W, 30 W, 50 W, 60 W, 100 W, 150 W, 200 W, 250 W, 500 W, 2 kW, 3 kW, 20 kW, 50 kW, etc., or between any of these values.

Laser pulses can be output by the laser source 104 at a pulse repetition rate in a range from 5 kHz to 5 GHz. It will be appreciated, however, that the pulse repetition rate can be less than 5 kHz or larger than 5 GHz. Thus, laser pulses can be output by the laser source 104 at a pulse repetition rate less than, greater than or equal to 5 kHz, 50 kHz, 100 kHz, 175 kHz, 225 kHz, 250 kHz, 275 kHz, 500 kHz, 800 kHz, 900 kHz, 1 MHz, 1.5 MHz, 1.8 MHz, 1.9 MHz, 2 MHz, 2.5 MHz, 3 MHz, 4 MHz, 5 MHz, 10 MHz, 20 MHz, 50 MHz, 60 MHz, 100 MHz, 150 MHz, 200 MHz, 250 MHz, 300 MHz, 350 MHz, 500 MHz, 550 MHz, 600 MHz, 900 MHz, 2 GHz, 10 GHz, etc., or between any of these values.

In addition to wavelength, average power and, when the beam of laser energy is manifested as a series of laser pulses, pulse duration and pulse repetition rate, the beam of laser energy delivered to the workpiece 102 can be characterized by one or more other characteristics such as pulse energy, peak power, etc., which can be selected (e.g., optionally based on one or more other characteristics such as wavelength, pulse duration, average power and pulse repetition rate, etc.) to irradiate the workpiece 102 at the process spot at an optical intensity (measured in W/cm²), fluence (measured in J/cm²), etc., sufficient to process the workpiece 102 (e.g., to form one or more features).

Examples of types of lasers that the laser source 104 may be characterized as gas lasers (e.g., carbon dioxide lasers, carbon monoxide lasers, excimer lasers, etc.), solid-state lasers (e.g., Nd:YAG lasers, etc.), rod lasers, fiber lasers, photonic crystal rod/fiber lasers, passively mode-locked solid-state bulk or fiber lasers, dye lasers, mode-locked diode lasers, pulsed lasers (e.g., ms-, ns-, ps-, fs-pulsed lasers), CW lasers, QCW lasers, or the like or any combination thereof. Depending upon their configuration, gas lasers (e.g., carbon dioxide lasers, etc.) may be configured to operate in one or more modes (e.g., in CW mode, QCW mode, pulsed mode, or any combination thereof). Specific examples of laser sources that may be provided as the laser source 104 include one or more laser sources such as: the BOREAS, HEGOA, SIROCCO or CHINOOK series of lasers manufactured by EOLITE; the PYROFLEX series of lasers manufactured by PYROPHOTONICS; the PALADIN Advanced 355, DIAMOND series (e.g., DIAMOND E, G, J-2, J-3, J-5 series), the FLARE NX, MATRIX QS DPSS, MEPHISTO Q, AVIA LX, AVIA NX, RAPID NX, HYPERRAPID NX, RAPID, HELIOS, FIDELITY, MONACO, OPERA, or RAPID FX series of lasers manufactured by COHERENT; the ASCEND, EXCELSIOR, EXPLORER, HIPPO, NAVIGATOR, QUANTA-RAY, QUASAR, SPIRIT, TALON, or VGEN series of lasers manufactured by SPECTRA PHYSICS; the PULSTAR- or FIRESTAR-series lasers manufactured by SYNRAD; the TRUFLOW-series of lasers (e.g., TRUFLOW 2000, 2600, 3000, 3200, 3600, 4000, 5000, 6000, 6000, 8000, 10000, 12000, 15000, 20000), TRUCOAX series of lasers (e.g., TRUCOAX 1000) or the TRUDISK, TRUPULSE, TRUDIODE, TRUFIBER, or TRUMICRO series of lasers, all manufactured by TRUMPF; the FCPA pJEWEL or FEMTOLITE series of lasers manufactured by IMRA AMERICA; the TANGERINE and SATSUMA series lasers (and MIKAN and T-PULSE series oscillators) manufactured by AMPLITUDE SYSTEMES; CL, CLPF, CLPN, CLPNT, CLT, ELM, ELPF, ELPN, ELPP, ELR, ELS, FLPN, FLPNT, FLT, GLPF, GLPN, GLR, HLPN, HLPP, RFL, TLM, TLPN, TLR, ULPN, ULR, VLM, VLPN, YLM, YLPF, YLPN, YLPP, YLR, YLS, FLPM, FLPMT, DLM, BLM, or DLR series of lasers manufactured by IPG PHOTONICS (e.g., including the GPLN-100-M, GPLN-500-QCW, GPLN-500-M, GPLN-500-R, GPLN-2000-S, etc.), or the like or any combination thereof.

### B. First Positioner

The first positioner 106 is arranged, located or otherwise disposed in the beam path 114 and is operative to diffract, reflect, refract, or the like, or any combination thereof, laser pulses that are generated by the laser source 104 (i.e., to “deflect” the laser pulses) so as to deflect or impart movement of the beam path 114 (e.g., relative to the scan lens 112) and, consequently, deflect or impart movement of the beam axis 118 relative to the workpiece 102. Generally, the first positioner 106 is operative to impart movement of the beam axis 118 relative to the workpiece 102 along the X-axis (or direction), the Y-axis (or direction), or a combination thereof. Although not illustrated, the X-axis (or X-direction) will be understood to refer to an axis (or direction) that is orthogonal to the illustrated Y- and Z-axes (or directions).

Generally, the first positioner 106 can be provided as a galvanometer mirror system, an AO deflector (AOD) system, an electro-optic (EO) deflector (EOD) system, a fast-steering mirror (FSM) system, or the like or any combination thereof. AODs of AOD systems generally include an AO cell formed of a material such as crystalline germanium (Ge), gallium arsenide (GaAs), wulfenite (PbMoO₄), tellurium dioxide (TeO₂), crystalline quartz, glassy SiO₂, arsenic trisulfide (As₂S₃), lithium niobate (LiNbO₃), or the like or any combination thereof. EODs of EOD systems generally include an EO cell formed of lithium niobate, potassium tantalite niobate, etc. To the extent that AO cells and EO cells are configured to transmit an incident beam of laser energy, the AO and EO cells can be considered to be types of transmissive optical components.

### C. Second Positioner

The second positioner 108 is disposed in the beam path 114 and is operative to diffract, reflect, refract, or the like or any combination thereof, laser pulses that are generated by the laser source 104 and passed by the first positioner 106 (i.e., to “deflect” the laser pulses) so as to deflect or impart movement to the beam path 114 (e.g., relative to the scan lens 112) and, consequently, deflect or impart movement of the beam axis 118 relative to the workpiece 102. Generally, the second positioner 108 is operative to impart movement of the beam axis 118 relative to the workpiece 102 along the X-axis (or direction), the Y-axis (or direction), or a combination thereof.

In view of the above, it should be appreciated that the second positioner 108 can be provided as a micro-electro-mechanical-system (MEMS) mirror or mirror array, an AOD system, an electro-optic deflector (EOD) system, a fast-steering mirror (FSM) element (e.g., incorporating a piezoelectric actuator, electrostrictive actuator, voice-coil actuator, etc.), a galvanometer mirror system, a resonant scanning mirror system, rotating polygon scanner, or the like or any combination thereof.

In one embodiment, the second positioner 108 can be provided as a two-axis galvanometer mirror system including two galvanometer mirror components, i.e., a first galvanometer mirror component (e.g., an X-axis galvanometer mirror component) arranged to impart movement of the beam axis 118 relative to the workpiece 102 along the X-axis and a second galvanometer mirror component (e.g., a Y-axis galvanometer mirror component) arranged to impart movement of the beam axis 118 relative to the workpiece 102 along the Y-axis. In another embodiment, however, the second positioner 108 may be provided as a galvanometer mirror system including only a single galvanometer mirror component arranged to impart movement of the beam axis 118 relative to the workpiece 102 along the X- and Y-axes. In yet other embodiments, the second positioner 108 may be provided as a rotating polygon mirror system, etc. It will thus be appreciated that, depending on the specific configuration of the second positioner 108 and the first positioner 106, the second positioning bandwidth may be greater than or equal to the first positioning bandwidth.

### D. Third Positioner

In the illustrated embodiment, the third positioner 110 includes one or more linear stages (e.g., each capable of imparting translational movement to the workpiece 102 along the X-, Y- and/or Z-directions), one or more rotational stages (e.g., each capable of imparting rotational movement to the workpiece 102 about an axis parallel to the X-, Y- and/or Z-directions), or the like or any combination thereof arranged and configured to impart relative movement between a workpiece 102 and the scan lens 112, and, consequently, to impart relative movement between the workpiece 102 and the beam axis 118. According to embodiments described herein, and although not illustrated, the third positioner 110 includes one or more stages configured and adapted to impart relative movement between the scan lens 112 and the first positioner 106.

In view of the configuration described herein, it should be recognized that movement of the process spot relative to the workpiece 102 (e.g., as imparted by the first positioner 106 and/or the second positioner 108) can be superimposed by any movement of the workpiece 102 or scan lens 112 as imparted by the third positioner 110.

In the illustrated embodiment, the third positioner 110 is operative to move the workpiece 102. In another embodiment, however, the third positioner 110 is arranged and operative to move the scan head 120 and, optionally, one or more components such as the first positioner 106 and the workpiece 102 may be kept stationary. In yet another embodiment, the third positioner 110 can be provided as a so-called “split-axis” positioning system in which the scan lens 112 and, optionally, one or more other components such as the first positioner 106 and second positioner 108, are carried by one or more linear or rotational stages (e.g., mounted on a frame, gantry, etc.) and the workpiece 102 is carried by one or more other linear or rotational stages. When provided as a “split-axis” positioning system, the third positioner 110 includes one or more linear or rotational stages arranged and operative to move one or more components such as the scan head 120 and one or more linear or rotational stages arranged and operative to move the workpiece 102. For example, the third positioner 110 may include a Y-stage for imparting movement of the workpiece 102 along the Y-direction and an X-stage for imparting movement of the scan head 120 along the X-direction. Some examples of split-axis positioning systems that may be beneficially or advantageously employed in the apparatus 100 include any of those disclosed in U.S. Pat. Nos. 5,751,585, 5,798,927, 5,847,960, 6,606,999, 7,605,343, 8,680,430, 8,847,113, or in U.S. Patent App. Pub. No. 2014/0083983, or any combination thereof, each of which is incorporated herein by reference in its entirety.

In one embodiment in which the third positioner 110 includes a Z-stage, the Z-stage may be arranged and configured to move the workpiece 102 along the Z-direction; in this case, the Z-stage may be carried by one or more of the other aforementioned stages for moving or positioning the workpiece 102, may carry one or more of the other aforementioned stages for moving or positioning the workpiece 102, or any combination thereof. In another embodiment in which the third positioner 110 includes a Z-stage, the Z-stage may be arranged and configured to move the scan head along the Z-direction; thus, in the case where the third positioner 110 is provided as a split-stage positioning system, the Z-stage may carry, or be carried by, the X-stage. Moving the workpiece 102 or the scan head along the Z-direction can result in a change in spot size at the workpiece 102.

In still another embodiment, one or more components such as the first positioner 106, second positioner 108, scan lens 112, etc., may be carried by an articulated, multi-axis robotic arm (e.g., a 2-, 3-, 4-, 5-, or 6-axis arm). In such an embodiment, the second positioner 108 and/or scan lens 112 may, optionally, be carried by an end effector of the robotic arm. In yet another embodiment, the workpiece 102 may be carried directly on an end effector of an articulated, multi-axis robotic arm (i.e., without the third positioner 110). In still another embodiment, the third positioner 110 may be carried on an end effector of an articulated, multi-axis robotic arm.

### E. Scan Lens

The scan lens 112 (e.g., provided as either a simple lens, or a compound lens) is generally configured to focus the beam of laser energy directed along the beam path, typically so as to produce a beam waist that can be positioned at or near the desired process spot. The scan lens 112 may be provided as a non-telecentric f-theta lens (as shown), a telecentric f-theta lens, an axicon lens (in which case, a series of beam waists are produced, yielding a plurality of process spots displaced from one another along the beam axis 118), or the like or any combination thereof.

In one embodiment, the scan lens 112 is provided as a fixed-focal length lens and is coupled to a scan lens positioner (e.g., a lens actuator, not shown) operative to move the scan lens 112 (e.g., so as to change the position of the beam waist along the beam axis 118). For example, the lens actuator may be provided as a voice coil operative to linearly translate the scan lens 112 along the Z-direction. In this case, the lens actuator can be considered here as a component of the aforementioned third positioner 110. Further, the fixed-focal length lens may be formed of a material such as fused silica, optical glass, zinc selenide, zinc sulfide, germanium, gallium arsenide, magnesium fluoride, etc. In another embodiment, the scan lens 112 is provided as a variable-focal length lens (e.g., a zoom lens, or a so-called “liquid lens” incorporating technologies currently offered by COGNEX, VARIOPTIC, etc.) capable of being actuated (e.g., via a lens actuator) to change the position of the beam waist along the beam axis 118. Changing the position of the beam waist along the beam axis 118 can result in a change in spot size at the workpiece 102.

As described above, in one embodiment, the scan lens 112 and the second positioner 108 are integrated into a common scan head 120. Thus, in an embodiment in which the apparatus 100 includes a lens actuator, the lens actuator may be coupled to the scan lens 112 (e.g., so as to enable movement of the scan lens 112 within the scan head 120, relative to the second positioner 108). Alternatively, the lens actuator may be coupled to the scan head 120 and be operative to enable movement of the scan head itself, in which case the scan lens 112 and the second positioner 108 would move together). In either case, the lens actuator can be considered here as a component of the aforementioned third positioner 110. In another embodiment, the scan lens 112 and the second positioner 108 are integrated into different housings (e.g., such that the housing in which the scan lens 112 is integrated is movable relative to the housing in which the second positioner 108 is integrated).

### F. Controller

Generally, the apparatus 100 includes one or more controllers, such as controller 122, to control, or facilitate control of, the operation of the apparatus 100. In one embodiment, the controller 122 is communicatively coupled (e.g., over one or more wired or wireless, serial or parallel, communications links, such as USB, RS-232, Ethernet, Firewire, Wi-Fi, RFID, NFC, Bluetooth, Li-Fi, SERCOS, MARCO, EtherCAT, or the like or any combination thereof) to one or more components of the apparatus 100, such as the laser source 104, the first positioner 106, the second positioner 108, third positioner 110, the lens actuator, the scan lens 112 (when provided as a variable-focal length lens), the fixture, etc., which are thus operative in response to one or more control signals output by the controller 122.

For example, the controller 122 may control an operation of the first positioner 106, the second positioner 108, or the third positioner 110, or any combination thereof, to impart relative movement between the beam axis and the workpiece so as to cause relative movement between the process spot and the workpiece 102 along a path or trajectory (also referred to herein as a “process trajectory”) within the workpiece 102. It will be appreciated that any two of these positioners, or all three of these positioners, may be controlled such that two positioners (e.g., the first positioner 106 and the second positioner 108, the first positioner 106 and the third positioner 110, or the second positioner 108 and the third positioner 110), or all three positioners simultaneously impart relative movement between the process spot and the workpiece 102 (thereby imparting a “compound relative movement” between the beam axis and the workpiece). Of course, at any time, it is possible to control only one positioner (e.g., the first positioner 106, the second positioner 108 or the third positioner 110) to impart relative movement between the process spot and the workpiece 102 (thereby imparting a “non-compound relative movement” between the beam axis and the workpiece).

Some other examples of operations that one or more of the aforementioned components can be controlled to perform include any operations, functions, processes, and methods, etc., as disclosed in aforementioned U.S. Pat. Nos. 5,751,585, 5,847,960, 6,606,999, 8,680,430, 8,847,113, or as disclosed in U.S. Pat. Nos. 4,912,487, 5,633,747, 5,638,267, 5,917,300, 6,314,463, 6,430,465, 6,600,600, 6,606,998, 6,816,294, 6,947,454, 7,019,891, 7,027,199, 7,133,182, 7,133,186, 7,133,187, 7,133,188, 7,244,906, 7,245,412, 7,259,354, 7,611,745, 7,834,293, 8,026,158, 8,076,605, 8,288,679, 8,404,998, 8,497,450, 8,648,277, 8,896,909, 8,928,853, 9,259,802, or in U.S. Patent App. Pub. Nos. 2014/0026351, 2014/0196140, 2014/0263201, 2014/0263212, 2014/0263223, 2014/0312013, or in German Patent No. DE102013201968B4, or in International Patent Pub. No. WO2009/087392, or any combination thereof, each of which is incorporated herein by reference in its entirety. In another example, the controller 122 may control an operation of any positioner that includes one or more AODs (e.g., in some embodiments, the first positioner 106, the second positioner 108, or a combination thereof) to change the spot shape or spot size of the beam of laser energy delivered to the process spot (e.g., by chirping an RF signal applied to one or more ultrasonic transducer elements of the one or more AODs, by applying a spectrally-shaped RF signal to one or more ultrasonic transducer elements of the one or more AODs, or the like or any combination thereof) as, for example, disclosed in International Patent Pub. No. WO2017/044646A1, which is incorporated herein by reference in its entirety. The applied RF signal may be chirped linearly, or non-linearly, in any desired or suitable manner. For example, the applied RF signal may be chirped at a first rate and then at a second rate to diffract a beam of laser energy transiting the AO cell in two different manners. In this case, the first rate may be slower than or faster than the second rate.

Generally, the controller 122 includes one or more processors operative to generate the aforementioned control signals upon executing instructions. A processor can be provided as a programmable processor (e.g., including one or more general purpose computer processors, microprocessors, digital signal processors, or the like or any combination thereof) operative to execute the instructions. Instructions executable by the processor(s) may be implemented software, firmware, etc., or in any suitable form of circuitry including programmable logic devices (PLDs), field-programmable gate arrays (FPGAs), field-programmable object arrays (FPOAs), application-specific integrated circuits (ASICs)—including digital, analog and mixed analog/digital circuitry—or the like, or any combination thereof. Execution of instructions can be performed on one processor, distributed among processors, made parallel across processors within a device or across a network of devices, or the like or any combination thereof.

In one embodiment, the controller 122 includes tangible media such as computer memory, which is accessible (e.g., via one or more wired or wireless communications links) by the processor. As used herein, “computer memory” includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, assembly language, hardware description language (e.g., VHDL, VERILOG, etc.), etc. Computer software is commonly stored in one or more data structures conveyed by computer memory.

Although not shown, one or more drivers (e.g., RF drivers, servo drivers, line drivers, power sources, etc.) can be communicatively coupled to an input of one or more components such as the laser source 104, the first positioner 106, the second positioner 108, the third positioner 110, the lens actuator, the scan lens 112 (when provided as a variable-focal length lens), the fixture, etc., for controlling such components. Accordingly, one or more components such as the laser source 104, the first positioner 106, the second positioner 108, the third positioner 110, the lens actuator, the scan lens 112 (when provided as a variable-focal length lens), the fixture, etc., can be considered to also include any suitable driver, as is known in the art. Each of such drivers would typically include an input communicatively coupled to the controller 122 and the controller 122 is operative to generate one or more control signals (e.g., trigger signals, etc.), which can be transmitted to the input(s) of one or more drivers associated with one or more components of the apparatus 100. Components such as the laser source 104, first positioner 106, second positioner 108, third positioner 110, lens actuator, the scan lens 112 (when provided as a variable-focal length lens), fixture, etc., are thus responsive to control signals generated by the controller 122.

Although not shown, one or more additional controllers (e.g., component-specific controllers) may, optionally, be communicatively coupled to an input of a driver communicatively coupled to a component (and thus associated with the component) such as the laser source 104, the first positioner 106, the second positioner 108, the third positioner 110, the lens actuator, the scan lens 112 (when provided as a variable-focal length lens), the fixture, etc. In this embodiment, each component-specific controller can be communicatively coupled to the controller 122 and be operative to generate, in response to one or more control signals received from the controller 122, one or more control signals (e.g., trigger signals, etc.), which can then be transmitted to the input(s) of the driver(s) to which it is communicatively coupled. In this embodiment, a component-specific controller may be operative as similarly described with respect to the controller 122.

In another embodiment in which one or more component-specific controllers are provided, the component-specific controller associated with one component (e.g., the laser source 104) can be communicatively coupled to the component-specific controller associated with one component (e.g., the first positioner 106, etc.). In this embodiment, one or more of the component-specific controllers can be operative to generate one or more control signals (e.g., trigger signals, etc.) in response to one or more control signals received from one or more other component-specific controllers.

### II. EMBODIMENTS ADDRESSING MISLOCATION OF PIVOT POINT RELATIVE TO THE SLEP

Constructed as described above, one or more components of the third positioner 110 enable movement of the scan lens 112 relative to the first positioner 106. Thus, the optical path length between the scan lens 112 and the first positioner 106 is variable. What follows below is a discussion of exemplary embodiments that may be used to compensate for the movement of the scan lens 112 relative to the first positioner 106 to ensure that the beam of laser energy propagating along the beam path 114 rotates about a pivot point that is located at, or at least very close to, the entrance pupil of the scan lens 112.

### A. Embodiment 1: Actuator-Driven First Positioner

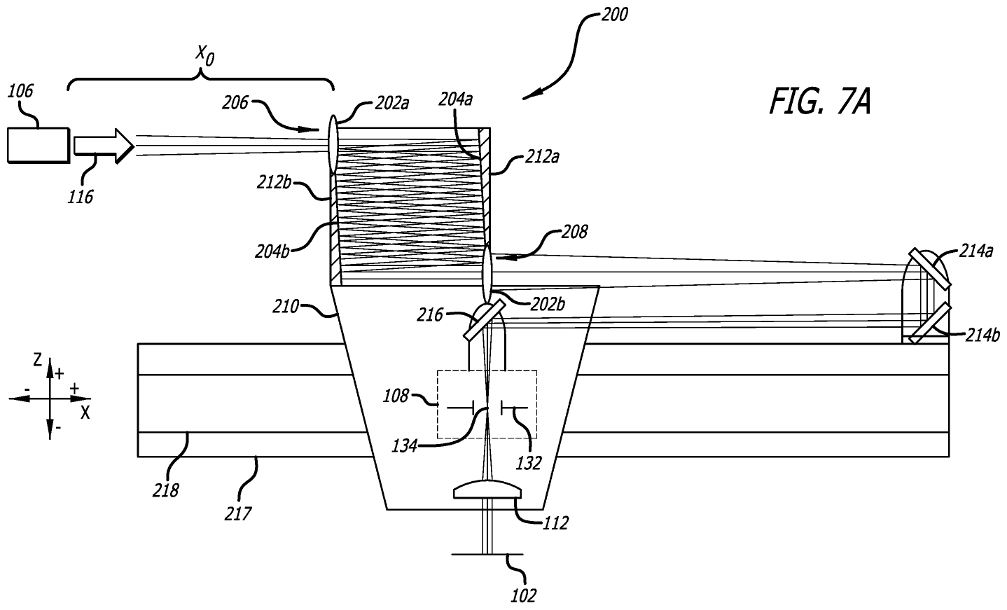

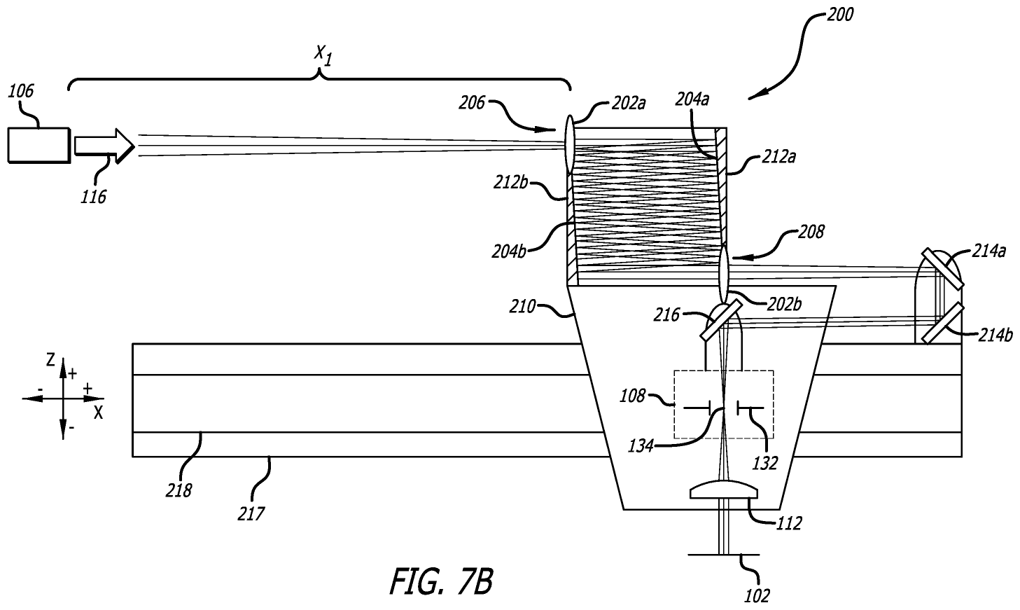

FIGS. 5 and 6 show an embodiment of an actuator-driven first positioner 106. As shown in FIG. 5, the first positioner 106 is coupled to an actuator 150 (e.g., a linear motion stage), and fixed relay optics 126 are arranged within the beam path 114 at a location between the first positioner 106 and the scan lens 112. In embodiments in which the scan lens 112 is coupled to one or more actuators of the third positioner 110 (e.g., to one or more linear actuators operative to move the scan lens 112 along any of the X-, Y- and/or Z-directions), the actuator 150 is not a part of the third positioner 110. Nevertheless, the actuator 150 is arranged and operative to move the first positioner 106 in a direction that corresponds to the direction of movement of the scan lens 112 as imparted by the third positioner 110. As will be appreciated, the actuator 150 is operative (e.g., in response to one or more commands output by the controller 122) to move the first positioner 106 so as to maintain a constant (or at least substantially constant) optical path length between the first positioner 106 and the entrance pupil 132 of the scan lens 112 when the scan lens 112 moves (e.g., as shown in FIG. 6). Maintaining the optical path length ensures that the beam of laser energy 116 has acceptable telecentricity when directed toward the workpiece 102. While FIG. 6 shows the scan lens 112 moving toward the fixed relay optics 126, it will be appreciated that the scan lens 112 may be moved away from the fixed relay optics 126, whereupon the actuator 150 may move the first positioner 106 toward the fixed relay optics 126 so as to maintain a constant optical path length between the first positioner 106 and the entrance pupil 132.

During operation, the actuator 150 can move the first positioner 106 by an amount that is equal to or different from the distance across which the scan lens 112 moves. For example, in one embodiment, the fixed relay optics 126 have a magnification, M, equal to (or at least substantially equal to) 1, such that the distance that the first positioner 106 must move along the beam path away from the fixed relay optics 126 to re-position the pivot point 134 at the center of the entrance pupil 132 is equal to (or at least substantially equal to) that the distance that the pivot point 134 moves along the beam path. In another example embodiment, the fixed relay optics 126 have a magnification, M, greater than 1, such that the distance that the first positioner 106 must move along the beam path away from the fixed relay optics 126 to re-position the pivot point 134 at the center of the entrance pupil 132 is less that the distance that the pivot point 134 moves along the beam path. For example, in one embodiment, the fixed relay optics 126 can have a magnification of M equal to (or at least substantially equal to) 2, so, if the scan lens 112 is moved along the beam path 114 toward the fixed relay optics 126 by 100 mm, then the actuator 150 need only move the first positioner 106 along the beam path 114 a distance of 25 mm (i.e., 100 mm/M²=25 mm). It will be appreciated that the magnification of the fixed relay optics 126 may be tailored in any other manner desired or beneficial.

FIGS. 5 and 6 illustrate a configuration in which the actuator 150 moves the first positioner 106 along a direction that is different from the direction in which the scan lens 112 is moveable. It will nevertheless be appreciated that the actuator 150 may move the first positioner 106 along a direction or any other direction provided that, for example, one or more mirrors are arranged within the beam path to adequately relay the beam path 114 from the first positioner 106 to the scan lens 112.

### B. Embodiment 2: Moveable Optical Relay System

As discussed above, optical relay systems are operative to locate the image of the first positioner 106 at the entrance pupil 132 of the scan lens 112, thereby causing the beam of laser energy 116 propagating along the beam path 114 to rotate about a pivot point 134 that is located at, or at least very close to, the entrance pupil 132 of the scan lens 112. Movement of the scan lens 112 relative to the first positioner 106 (or the second positioner 108) can result in mislocation of the image of the first positioner 106 away from the entrance pupil 132. In one embodiment, an optical relay system 200 may be moved synchronously with the movement of the scan lens 112, thereby maintaining the location of the pivot point 134 at the entrance pupil 132, thereby causing the beam of laser energy 116 to have acceptable telecentricity when directed toward the workpiece 102.

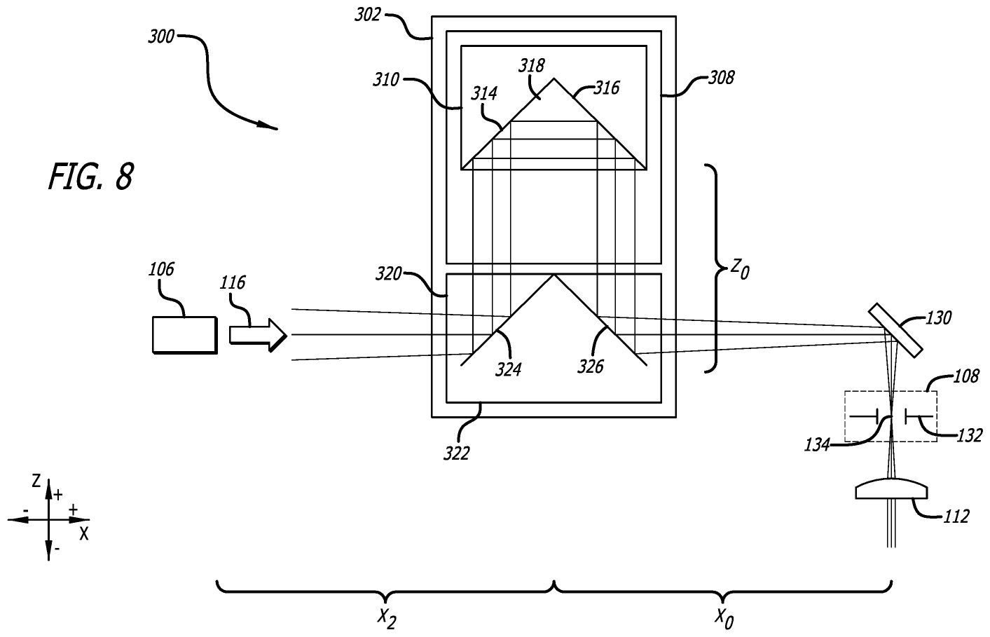

FIGS. 7A and 7B show two spatial states of an embodiment of a moveable optical relay system, which includes an optical relay 200 arranged in optical communication with the first positioner 106 and mounted on a component of the third positioner 110 (e.g., as illustrated, a linear stage 218 operative to move the optical relay 200 along the X-axis), and a plurality of mirrors (e.g., mirrors 214a, 214b, and 216). The optical relay 200 is mounted to a carriage 210 which, in turn, is moveable by the linear stage 218 (e.g., in response to one or more commands output by the controller 122). Likewise, the mirror 216, the second positioner 108 and the scan lens 112 are mounted on the carriage 210 of the linear stage 218, along with the optical relay 200. The linear stage 218 can be mounted to a structure 217, such as frame or gantry of the laser processing apparatus 100. In another embodiment, the optical relay 200 may be mounted to an auxiliary stage (not shown) instead of stage 218. During use, the auxiliary stage may position the optical relay 200 in correspondence with the motion imparted to the second positioner 108 and the scan lens 112 by the linear stage 218. The mirrors 214a and 214b (e.g., fold mirrors) are mounted to the structure 217. Thus, the linear stage 218 can move the second positioner 108 and the scan lens 112, as well as the optical relay 200 and mirror 216, relative to the first positioner 106 and the mirrors 214a and 214b. As illustrated, the mirrors 214a, 214b and 216 are arranged to place the optical relay 200 in optical communication with the scan lens 112.

The optical relay 200 further includes an optical input 206, an optical output 208, a first reflector 212a having a first reflective surface 204a and a second reflector 212b having a second reflective surface 204b. The optical relay 200 further includes a first lens 202a mounted in the optical input 206 and a second lens 202b mounted in the optical output 208.

In the illustrated embodiment, the first reflective surface 204a and the second reflective surface 204b are parallel to (or at least substantially parallel to) each other. It will be appreciated that the first reflective surface 204a and the second reflective surface 204b may not be parallel to each other. Based on the construction described above, the beam of laser energy 116 enters the optical input 206 through the first lens 202a and is incident upon the first reflective surface 204a where it is reflected to the second reflective surface 204b. The beam of laser energy 116 is reflected back and forth multiple times between the reflective surfaces 204a, 204b until it exits the optical relay 200 through optical output 208. The folding of the optical path between the reflective surfaces 204a and 204b enables the optical relay 200 to be compact enough to be mounted to the carriage 210. After exiting the optical output 208 through the second lens 202b, the beam of laser energy 116 propagates to the mirror 214a. The beam of laser energy 116 is reflected from the mirror 214a to mirror 214b, where it is then reflected to a mirror 216, which is arranged to reflect the beam of laser energy 116 to the scan lens 112 (e.g., via the second positioner 108). In the illustrated embodiment, the second positioner 108 is provided as a two-axis galvanometer mirror system and the entrance pupil 132 of the scan lens 112 is located between the X- and Y-axis galvanometer mirror components thereof. Under certain operating conditions of the apparatus 100, the power of the beam of laser energy 116 is high enough to cause damage to the reflective surfaces 204a and 204b if focused directly thereon. To avoid this, in the illustrated embodiment, the first lens 202a is configured to focus the beam of laser energy 116 at a point between the first reflective surface 204a and the second reflective surface 204b (e.g., nominally halfway between the reflective surfaces 204a and 204b), thereby reducing the laser fluence at the surfaces 204a and 204b enough to avoid damage to them.

Generally, the optical relay 200 may be configured to impart a magnification to the beam of laser energy 116 in order to compensate for changes in the optical path length due to folding of the optical path into 2 or more legs (e.g., depending on the configuration of the apparatus 100) in order to keep the pivot point 134 located at or near the scan lens entrance pupil 132.

In one example embodiment, referring to FIG. 7A, the optical input 206 is located at distance X₀ from first positioner 106. As shown in FIG. 7B, the optical input 206 is relocated to distance X₁ from the first positioner 106, having been moved a distance of D=X₁−X₀ (e.g., upon operation of the linear stage 218). When the optical relay 200 is moved in the +X-direction, the distance between the optical output 208 and the scan lens 112 changes by a factor of 2 because the beam of laser energy 116 is folded into two legs by the mirrors 214a and 214b. As such, the effect is that the image of the first positioner 106 has moved away from the scan lens 112 by a distance 2*D, potentially moving the relayed pivot point 134 out of the entrance pupil 132, which would result in telecentric errors in the beam directed to the workpiece 102. To account for this, in this embodiment, the lenses 202a and 202b may impart a lateral magnification of M=sqrt(2)=1.414 to the beam of laser energy 116, such that the beam exiting the optical output 208 has a width 1.414 times the width of the beam entering the optical input 206. The resulting longitudinal magnification is M²=2, such that the relayed pivot point 134 moves a distance of 2*D, thereby maintaining the location of the relayed pivot point 134, as well as the beam size of the beam of laser energy 116, at the entrance pupil 132 as the scan lens 112 and the optical relay 200 are moved by the linear stage 218.

In another example embodiment, the optical path may be folded into three legs, such that when the optical input 206 is relocated to distance X₁ from the first positioner 106, having been moved a distance of D=X₁−X₀ (e.g., upon operation of the linear stage 218). When the optical relay 200 is moved in the +X-direction, the distance between the optical output 208 and the scan lens 112 would change by a factor of 3 because the beam of laser energy 116 is folded into three legs. As such, the effect is that the image of the first positioner 106 has moved away from the scan lens 112 by a distance 3*D. To account for this, in this embodiment, the lenses 202a and 202b may impart a lateral magnification of M=sqrt(3)=1.732 to the beam of laser energy 116, such that the beam exiting the optical output 208 has a width 1.732 times the width of the beam entering the optical input 206. The resulting longitudinal magnification is M²=3, such that the relayed pivot point 134 moves a distance of 3*D, thereby maintaining the location of the relayed pivot point 134, as well as the beam size of the beam of laser energy 116, at the entrance pupil 132 as the scan lens 112 and the optical relay 200 are moved by the linear stage 218. It will be appreciated that in other possible configurations of the apparatus 100, the optical path between the relay 200 may be folded into more than three legs, and that the lenses 202a and 202b may be configured to impart the appropriate magnification to the beam of laser energy 116 to compensate for this and to maintain the pivot point 134 at or near the entrance pupil 132.

Although the second positioner 108 is illustrated in FIGS. 7A and 7B as overlapping the entrance pupil 132, it will be appreciated that the second positioner 108 may alternatively be located so as to not overlap the entrance pupil 132. For example, the mirror 216 shown in FIGS. 7A and 7B may be replaced with the second positioner 108.

### C. Embodiment 3: Optical Delay Line with Retroreflector

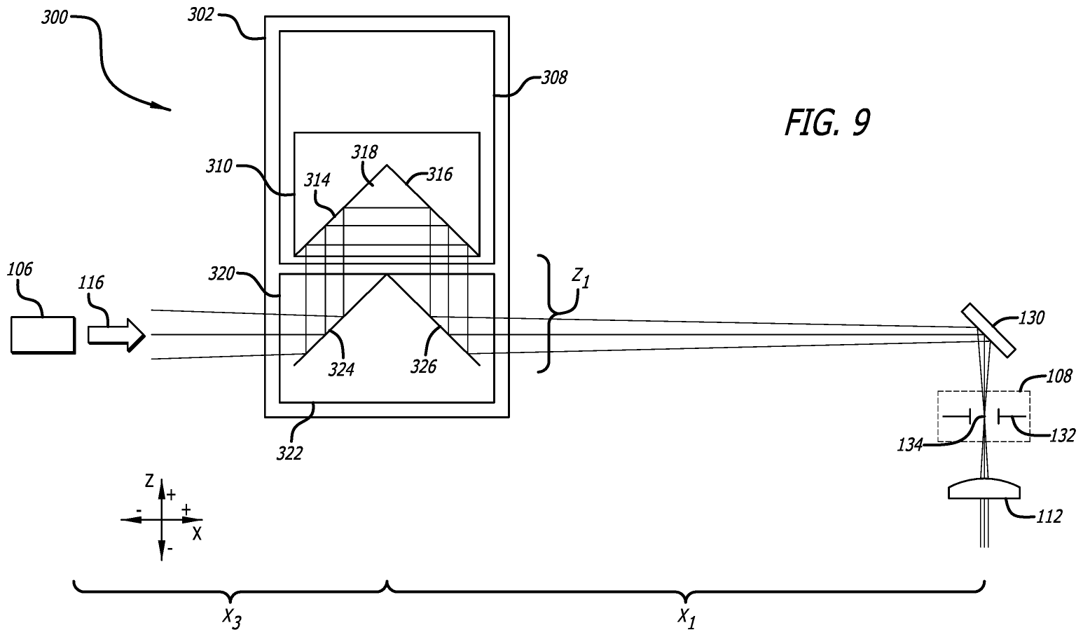

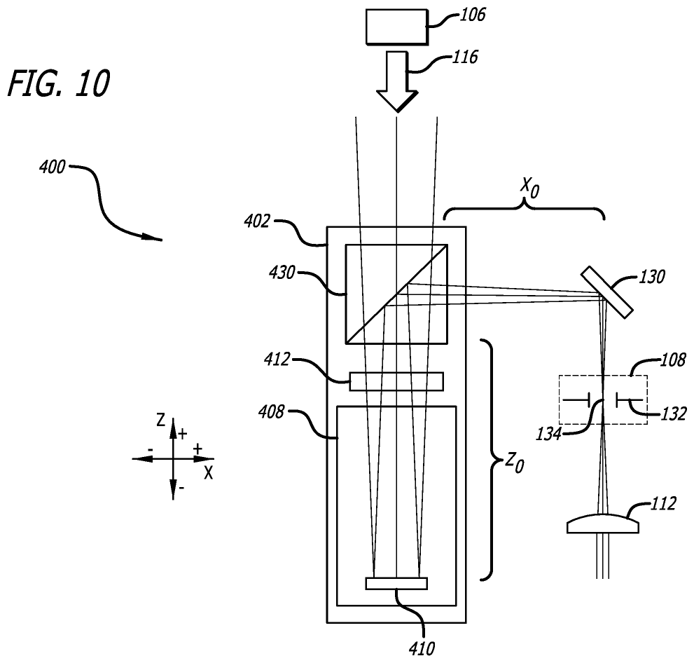

FIGS. 8 and 9 show positional states of an optical relay system provided as an optical delay line incorporating a retroreflector, such as optical delay line 300. The optical delay line 300 receives a beam of laser energy 116 from the first positioner 106 and relays it to a scan lens 112 via a fold mirror 130. It should be appreciated that the fold mirror 130 is optional, and may be omitted if the orientation(s) of one or more other components of the laser processing apparatus 100 (e.g., the first positioner 106, the second positioner 108, the scan lens 112, the optical delay line 300, or the like or any combination thereof) are modified to ensure that the beam of laser energy 116 propagates from the first positioner 106 to the scan lens 112. The beam of laser energy 116 is thus directed to a relayed pivot point 134 at or near the entrance pupil 132 of the scan lens 112.

Generally, the optical delay line 300 includes a motion system 308 (e.g., a linear stage), a retroreflector 310, a relay reflector 320, and a delay line body 302. The motion system 308, the retroreflector 310 and the relay reflector 320 are mounted on the delay line body 302, and the retroreflector 310 is movable relative to the relay reflector 320 by the motion system 308. In one embodiment, the optical delay line 300 is installed within the laser processing apparatus 100 so as to be positionally fixed relative to the first positioner 106 and the scan lens 112 is moveable relative to the optical delay line 300. In another embodiment, the optical delay line 300 is moveable relative to the first positioner 106 and may be positionally fixed relative to the scan lens 112. For example, the optical delay line 300 may be coupled to one or more actuators of the third positioner 110 (e.g., to one or more linear actuators operative to move the scan lens 112 along any of the X-, Y- and/or Z-directions). In another embodiment, the optical delay line 300 is moveable relative to the first positioner 106 and the scan lens 112.

In the illustrated embodiment, the retroreflector 310 is a corner reflector (a.k.a. “corner-cube”) that includes a first reflective surface 314, a second reflective surface 316, and a third reflective surface 318 oriented substantially orthogonal to each other. In another embodiment, the retroreflector 310 need not have a third reflective surface 318. In other embodiments, the retroreflector 310 may also be provided as a pair of mirrors or as a spherical retroreflector. Those skilled in the art will appreciate that that any variety of retroreflector may be used in the optical delay line 300. In the illustrated embodiment, when the retroreflector 310 is provided with three reflective surfaces 314, 316 and 318, the beams propagating to the retroreflector 310 and the beams propagating from the retroreflector 310 stay parallel regardless of the orientation of the beam to the reflective surfaces of the retroreflector 310.

The relay reflector 320 is configured to reflect the beam of laser energy 116 to the retroreflector 310 and to reflect the beam of laser energy returning from the retroreflector 310 to the scan lens 112. In the illustrated embodiment, the relay reflector 320 includes a first reflective surface 324 and a second reflective surface 326 attached to or formed on a relay reflector body 322. In the illustrated embodiment, the first reflective surface 324 and the second reflective surface 326 are oriented orthogonal to each other. In another embodiment, the first reflective surface 324 and the second reflective surface 326 may not be oriented orthogonal to each other. In another embodiment, the relay reflector 320 may be provided as two mirrors mounted to the relay reflector body 322. It will be appreciated that any variety of optics or optical surfaces may be mounted to or formed on the relay reflector body 322.

In an embodiment in which the scan lens 112 is moveable relative to the optical delay line 300 (e.g., the optical delay line 300 is installed within the laser processing apparatus 100 so as to be positionally fixed relative to the first positioner 106) as the scan lens 112 is moved (e.g., in the +X-direction) relative to the first positioner 106, the retroreflector 310 is moved (e.g., in the −Z-direction) relative to the relay reflector 320. Accordingly, the optical path length between the scan lens 112 and the first positioner 106 is maintained so that the pivot point 134 of the beam of laser energy 116 stays located at or near the entrance pupil 132 of the scan lens 112 when the scan lens 112 is moved. For example, with reference to FIGS. 8 and 9, during use, the scan lens 112 is moved in the +X-direction from a distance X₀ relative to the optical delay line 300 (as shown in FIG. 8) to a distance X₁ relative to the optical delay line 300 (as shown in FIG. 9), a change of ΔX=X₁−X₀. Synchronously with movement of the scan lens 112, the retroreflector 310 is moved in the −Z-direction from a distance Z₀ relative to the relay reflector 320 (as shown in FIG. 8) to a distance Z₁ relative to the relay reflector 320 (as shown in FIG. 9), a change in position of ΔZ=Z₀−Z₁. In this embodiment, ΔX≈2ΔZ. Since the optical path is folded into two legs in the Z-direction by the optical delay line 300, when ΔX≈2ΔZ, the original optical path length from the first positioner 106 to the scan lens 112 is conserved.

In an embodiment in which the optical delay line 300 is moveable (e.g., with the scan lens 112) relative to the first positioner 106, or is itself moveable relative to the scan lens 112, the retroreflector 310 can be moved (e.g., in the −Z-direction) relative to the relay reflector 320 as the optical delay line 300 is moved (e.g., in the +X-direction) relative to the first positioner 106 (or relative to the scan lens 112). Accordingly, the optical path length between the scan lens 112 and the first positioner 106 is maintained so that the pivot point 134 of the beam of laser energy 116 stays located at or near the entrance pupil 132 of the scan lens 112 when the scan lens 112 is moved. For example, with reference to FIGS. 8 and 9, during use, the optical delay line 300 is moved in the +X-direction from a distance X₂ relative to the first positioner 106 to a distance X₃ relative to the first positioner 106, a change of ΔX=X₃−X₂. Synchronously with movement of the optical delay line 300 in the +X direction, the retroreflector 310 is moved in the −Z-direction from a distance Z₀ relative to the relay reflector 320 (as shown in FIG. 8) to a distance Z₁ relative to the relay reflector 320 (as shown in FIG. 9), a change in position of ΔZ=Z₀−Z₁. In this embodiment, ΔX≈2ΔZ. Since the optical path is folded into two legs in the Z-direction by the optical delay line 300, when ΔX≈2ΔZ, the original optical path length from the first positioner 106 to the scan lens 112 is conserved.

It will be appreciated that the optical delay line 300 may be configured to fold the optical path between the first positioner 106 and the scan lens 112 into any number of legs and, as such, may provide any ratio between ΔX and ΔZ. For example, the optical delay line 300 may include two sub-delay lines (not shown), each folding the optical path twice, so that a ratio of ΔX=4ΔZ would conserve the optical path length. Furthermore, any number of optical relay lines or subsystems may be provided to conserve the optical path length in any multiple desired or beneficial.

Although the second positioner 108 is illustrated in FIGS. 8 and 9 as overlapping the entrance pupil 132 (e.g., as discussed above with respect to FIGS. 7A and 7B), it will be appreciated that the second positioner 108 may alternatively be located so as to not overlap the entrance pupil 132. For example, the fold mirror 130 may be replaced with the second positioner 108. During operation, in similar fashion to the embodiments described above, the second positioner 108 and the scan lens 112 may be scanned along the X-direction, and the optical path length may be conserved by synchronously moving the retroreflector 310 relative to the relay reflector 320.

It should be appreciated that the X, Y, or Z directions are used arbitrarily in the description of this embodiment. For example, the optical delay line 300 may be oriented such that the change in position between the retroreflector 310 and the relay reflector 320 is also in the X-direction. The absolute value of the change in the distance between the retroreflector 310 and the relay reflector 320 (and, correspondingly, the absolute value of the change in distance between the optical delay line 300 and the scan lens 112) is what results in conservation of the optical path length. This is also true for the other embodiments described below.

### D. Embodiment 4: Optical Delay Line with Polarizing Beam Splitter

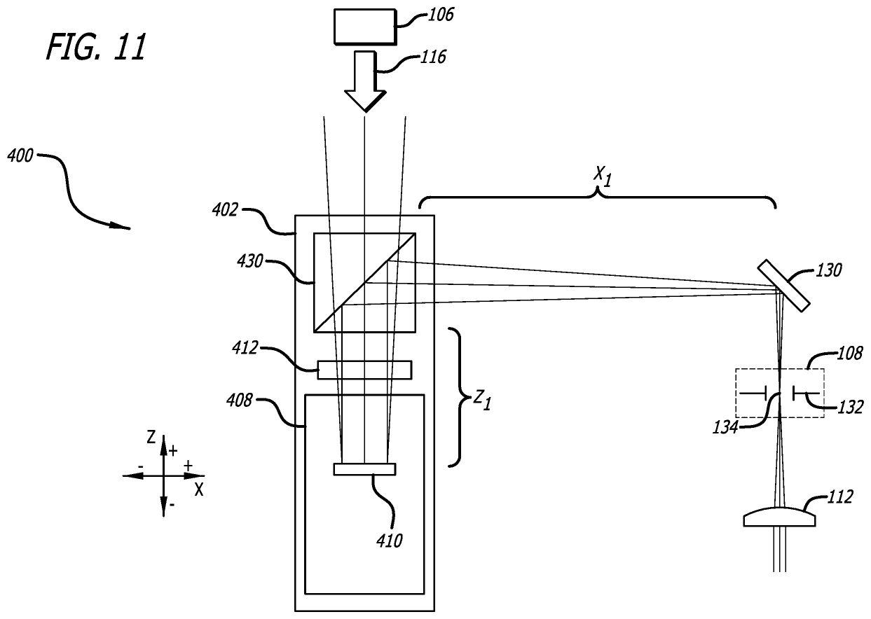

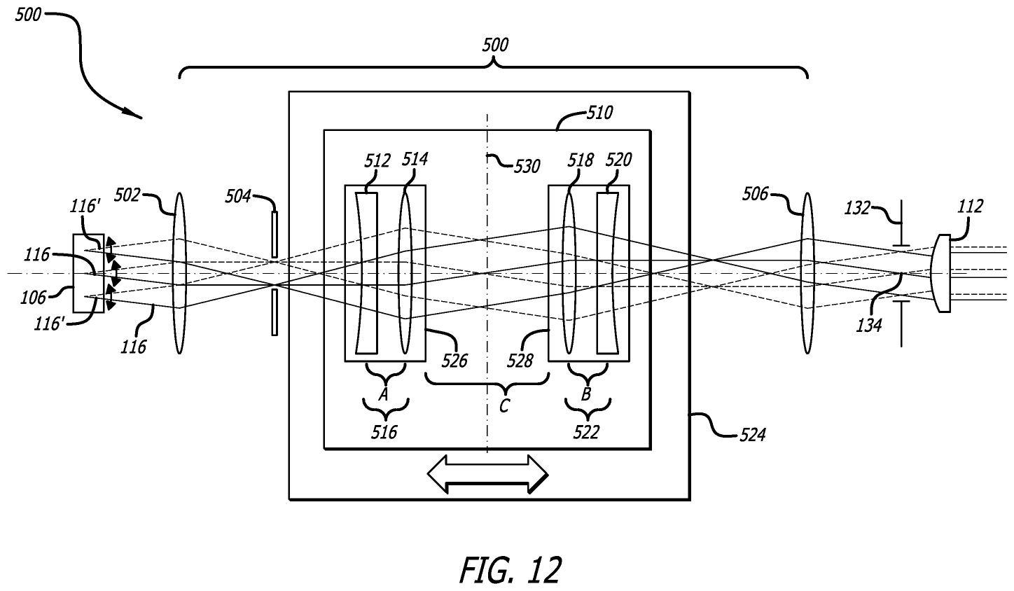

FIGS. 10 and 11 show positional states of an optical relay system provided as an optical delay line incorporating a polarizing beam splitter, such as optical delay line 400. The optical delay line 400 receives a beam of laser energy 116 from the first positioner 106 and relays it to a scan lens 112 via a fold mirror 130. In this embodiment, the beam of laser energy 116 initially transmitted to the optical delay line 400 is linearly polarized. It should be appreciated that the fold mirror 130 is optional, and may be omitted if the orientation(s) of one or more other components of the laser processing apparatus 100 (e.g., the first positioner 106, the second positioner 108, the scan lens 112, the optical delay line 400, or the like or any combination thereof) are modified to ensure that the beam of laser energy 116 propagates from the first positioner 106 to the scan lens 112. The beam of laser energy 116 is thus directed to a relayed pivot point 134 at or near the entrance pupil 132 of the scan lens 112.

Generally, the optical delay line 400 includes a polarizing beamsplitter 430, a retarder 412, a reflector 410, a motion system 408 (e.g., a linear stage), and a delay line body 402. The polarizing beamsplitter 430, retarder 412 (e.g., a quarter-wave plate), and motion system 408 are mounted on the delay line body 402, and the reflector 410 is movable by the motion system 408. The optical delay line 400 may be installed within the laser processing apparatus 100 so as to be positionally fixed relative to the first positioner 106 and the scan lens 112, or may be moveable relative to the first positioner 106 and/or scan lens 112 (e.g., as discussed above with respect to the optical delay line 300).

The retarder 412 is arranged between the polarizing beamsplitter 430 and the reflector 410, and is configured to alter the polarization of the beam of laser energy transmitted therethrough (e.g., from linear polarization to circular polarization, or vice-versa). The reflector 410 is arranged and configured to reflect the incident beam of laser energy 116 back toward the polarizing beamsplitter 430. Accordingly, the polarization of the beam of laser energy 116 propagating from the polarizing beamsplitter 430 is converted from linear to circular polarization at the retarder 412, and the polarization of the beam of laser energy 116 propagating from the reflector 410 is converted from circular to linear polarization at the retarder 412. In this case, however, the polarization direction of the beam of laser energy 116 reflected back to the polarizing beamsplitter 430 (i.e., from the retarder 412) is rotated by 90 degrees relative to the polarization direction of the beam of laser energy 116 propagating from the polarizing beamsplitter 430 (i.e., to the retarder 412). Accordingly, the beam of laser energy 116 reflected back to the polarizing beamsplitter 430 is reflected by the polarizing beamsplitter 430 to the scan lens 112 (e.g., via the fold mirror 130).

The reflector 410 is mounted on the motion system 408, which is attached to the delay line body 402, which is configured to change to position of the reflector 410 relative to the polarizing beamsplitter 430. Optionally, the polarizing beamsplitter 430 may be mounted on the motion system 408 so that the position of the polarizing beamsplitter 430 is changed relative to the reflector 410.

In an embodiment in which the scan lens 112 is moveable relative to the optical delay line 400 (e.g., the optical delay line 400 is installed within the laser processing apparatus 100 so as to be positionally fixed relative to the first positioner 106), as the scan lens 112 is moved (e.g., in the +X-direction) relative to the first positioner 106, the reflector 410 is moved (e.g., in the +Z-direction) relative to the polarizing beamsplitter 430. Accordingly, the optical path length between the scan lens 112 and the first positioner 106 is maintained so that the pivot point 134 of the beam of laser energy stays located at or near the entrance pupil 132 of the scan lens 112 when the scan lens 112 is moved. For example, with reference to FIGS. 10 and 11, the scan lens 112 is moved in the +X-direction from a distance X₀ relative to the optical delay line 400 (as shown in FIG. 10) to a distance X₁ relative to the optical delay line 400 (as shown in FIG. 11), a change of ΔX=X₁−X₀. Synchronously with the movement of the scan lens 112, the reflector 410 is moved in the +Z-direction from a distance Z₀ relative to the polarizing beamsplitter 430 (as shown in FIG. 10) to a distance Z₁ relative to the polarizing beamsplitter 430 (as shown in FIG. 11), a change in position of ΔZ=Z₀−Z₁ In this embodiment, ΔX≈2ΔZ. Since the optical path is folded into two legs in the Z-direction by the optical delay line 400, when ΔX≈2ΔZ, the original optical path length from the first positioner 106 to the scan lens 112 is conserved.

It will be appreciated that the optical delay line 400 may be configured to fold the optical path between the first positioner 106 and the scan lens 112 into any number of legs (e.g., to provide any ratio between ΔX and ΔZ). For example, the optical delay line 400 may include two sub-delay lines (not shown), each folding the optical path into two legs, so that a ratio of ΔX=4ΔZ would conserve the optical path length. Any number of optical relay systems or subsystems may be provided to conserve the optical path length in any multiple desired or beneficial.

In the embodiment discussed above, the reflector 410 is provided as a zero phase-shift reflector. In another embodiment, however, the reflector 410 can be provided as reflective phase retarder, such as a half-wave reflective phase retarder configured to rotate the polarization direction of the beam of laser energy 116 upon reflecting the beam of laser energy 116 back toward the polarizing beamsplitter 430. In this case, the retarder 412 is not required. The use of a half-wave reflective phase retarder may be desirable if the beam of laser energy is in the UV, mid-wavelength infrared or long-wavelength infrared ranges of the electromagnetic spectrum.

Although the second positioner 108 is illustrated in FIGS. 10 and 11 as overlapping the entrance pupil 132 (e.g., as discussed above with respect to FIGS. 7A and 7B), it will be appreciated that the second positioner 108 may alternatively be located so as to not overlap the entrance pupil 132. For example, the fold mirror 130 may be replaced with the second positioner 108. During operation, in similar fashion to the embodiments described above, the second positioner 108 and the scan lens 112 may be scanned in the X-direction, and the optical path length may be conserved by synchronously moving the reflector 410 relative to the polarizing beamsplitter 430.

### E. Embodiment 5: Zoom Optical Relay System

As discussed above, some embodiments of optical relay systems may have a fixed magnification operative to achieve a target spot size at the surface of a workpiece while ensuring that the beam of laser energy 116 propagating along the beam path 114 rotates about a pivot point 134 that is located at, or very close to, the entrance pupil 132 of the scan lens 112. According to other embodiments, however, optical relay systems may be provided that are operative to relay the pivot point 134 of the beam to the entrance pupil 132 of the scan lens 112 and to change the magnification of the beam of laser energy (e.g., to adjust or maintain laser spot size at the workpiece 102). What follows is a discussion of exemplary embodiments of such an optical relay system capable of variable magnification, collimated beam output, and constant pivot point location. Such an optical relay system may be placed optically downstream of one or more of the positioners in the system (e.g., after the first positioner 106 or the second positioner 108).

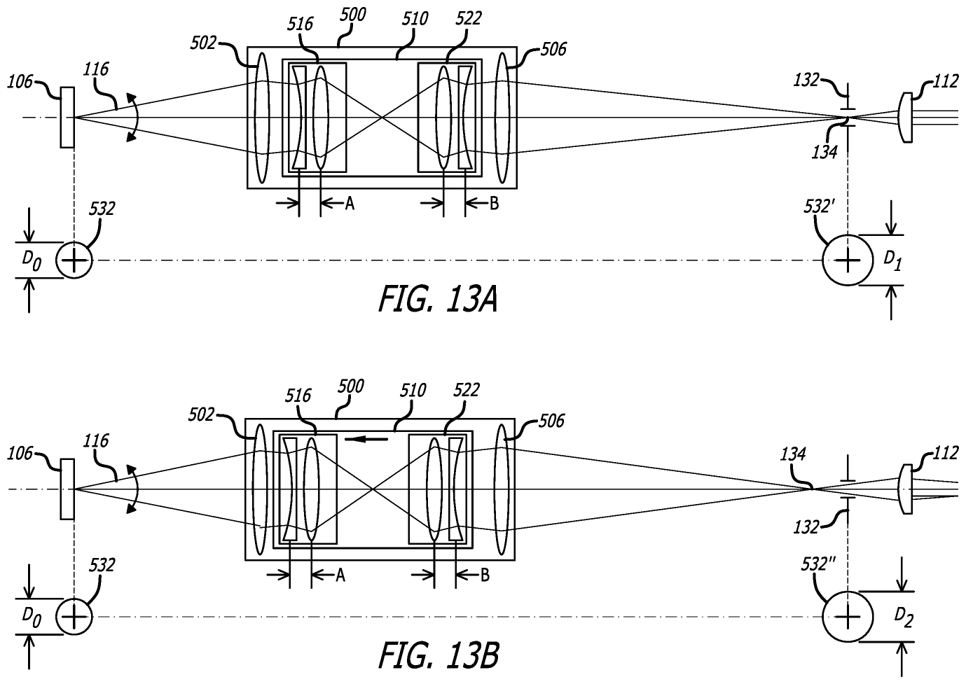

FIG. 12 shows an example embodiment of an optical relay system 500 configured to relay the image (or focal plane) of the first positioner 106 (or the second positioner 108) to the entrance pupil 132 of a scan lens 112. In this embodiment, the position of the optical relay system 500 is fixed relative to the first positioner 106 (or the second positioner 108) and the scan lens 112. Optionally, as described below, the position of the optical relay system 500 (or its components) may be adjustable relative to the first positioner 106, the second positioner 108 and/or and the scan lens 112.

As shown, the relay system 500 may include a first lens 502, a zoom lens assembly 510 and a second lens 506. An aperture 504, operative to limit the light entering the zoom lens assembly 510 (e.g., to allow the diffraction orders to be separated, or to otherwise limit the angular range of the beam of laser energy 116 (and its marginal rays 116′) diffracted by the first positioner 106, or, the beam of laser energy 116 reflected by the second positioner 108), may be positioned between the first lens 502 and the zoom lens assembly 510. In the illustrated embodiment, the zoom lens assembly 510 is located between the first lens 502 and the second lens 506. Though the lenses 502 and 506 are shown in FIG. 12 as biconvex lenses, a variety of positive lenses (e.g., planar-convex, positive meniscus lenses, positive achromatic lenses, aspheric lenses, and the like, or arranged in doublets, triplets or any combination thereof) may be used, depending on the operational requirements of the apparatus 100.

In this embodiment, the zoom lens assembly 510 includes a first lens group 516 and a second lens group 522. The first lens group 516 is separated from the second lens group 522 by a fixed distance, C. The first lens group 516 includes a first lens 512 and a second lens 514, and the second lens group 522 includes a first lens 518 and a second lens 520. In the embodiment shown in FIG. 12, the first lens group 516 and the second lens group 522 may be provided as telephoto doublets arranged symmetrically with respect to a transverse centerline 530 of the zoom lens assembly 510. In this embodiment, in the first lens group 516, the first lens 512 is a plano-concave and the second lens 514 is a biconvex lens, and the lenses 512 and 514 are separated by a distance A. In the second lens group, the lens 518 is a biconvex lens and the second lens 520 is a plano-concave lens, and the lenses 518 and 520 are separated by a distance B and arranged in mirror-image symmetry with respect to the plano-concave lens 512 and the biconvex lens 514 of the first lens group 516. The distance A may be adjusted (also referred to herein as “adjustment of the first lens group 516”) by any suitable or desired means known in the art. Likewise, the distance B may be adjusted (also referred to herein as “adjustment of the second lens group 522”) by any suitable or desired means known in the art.

To adjust the magnification (also referred to herein as the “magnification set point”) of the optical relay system 500 in order to set or adjust the laser spot size of the beam of laser energy 116, the position of the zoom lens assembly 510 within the optical relay system 500 may be set or adjusted. The position of the zoom lens assembly 510 can be set manually (e.g., by the manufacturer of the apparatus 100, by a user or other operator of the apparatus 100, by an applications engineer or technician responsible for developing a process or recipe for processing the workpiece 102, or the like or any combination thereof) and then fixed in place. In another embodiment, the zoom lens assembly 510 may be mounted on a first positioner 524 (e.g. a linear stage, voice coil, optical mount, etc.) operative to change the position of the zoom lens assembly 510 (e.g., in response to one or more commands from the controller 122) within the optical relay system 500.

Similar to the adjustment of the position of the zoom lens assembly 510 within the optical relay system 500, adjustments of the first lens group 516 and the second lens group 522 may be done manually or by mounting the first lens group 516 and the second lens group 522 on a second positioner 526 and a third positioner 528, respectively. In this embodiment, when the magnification set point of the optical relay system 500 is set, adjustment of the first lens group 516 and the second lens group 522 may be required to achieve collimation of the beam of laser energy 116 between the first lens group 516 and the second lens group 522, thereby creating a pivot point between the lens groups 516 and 522. Also, the adjustment of the first lens group 516 and the second lens group 522 may be required to achieve collimation of the beam of laser energy 116 after the second lens 506, to locate the pivot point 134 at the scan lens entrance pupil 132. Adjustment of the first lens group 516 and the second lens group 522 can also be made as desired to adjust the effective focal length of the whole optical relay system 500, thereby maintaining the position of the pivot point 134 at or close to the scan lens entrance pupil 132. The adjustment of the first lens group 516 and the second lens group 522 can be done synchronously with, or sequentially (in any order), to the adjustment of the position of the zoom lens assembly 510 within the optical relay system 500, or by an iterative process.

Depending on optical performance requirements of the apparatus 100, alternate embodiments of the zoom lens assembly 510 may be used. For example, in one alternate embodiment, the spacing C between the first lens group 516 and the second lens group 522 may also be adjustable instead of fixed. In another embodiment, the first lens group 516 and the second lens group 522 may include various combinations of positive lenses (e.g., planar-convex, positive meniscus lenses, positive achromatic lenses, aspheric lenses, and the like, arranged in doublets, triplets or any combination thereof), and negative lenses (e.g. double concave, plano-concave, negative meniscus lenses, negative achromatic lenses, and the like, arranged in doublets, triplets or any combination thereof) in any order or spacing.

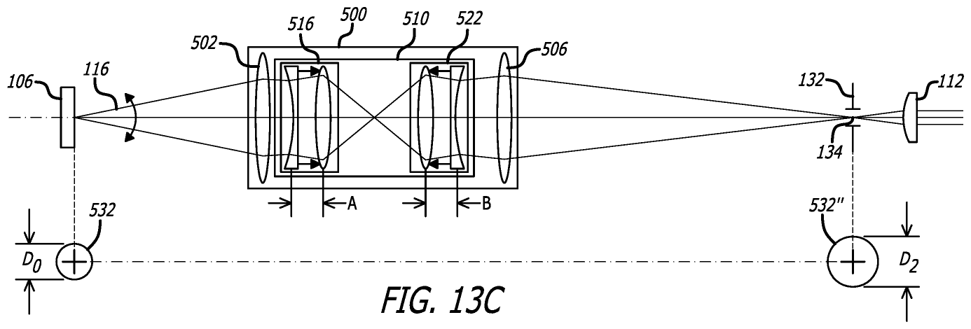

As described above, when the magnification set point of the optical relay system 500 is adjusted (e.g., to adjust or maintain the laser spot size at the workpiece 102), adjustment of the first lens group 516 and the second lens group 522 may be required. FIGS. 13A-13C show various positional states of the optical relay system 500, demonstrating an example of the effect of a change in the magnification set point on the laser spot size and the location of the pivot point 134, and how adjustments of the first lens group 516 and the second lens group 522 may adjust the location of the pivot point 134.

FIG. 13A shows the optical relay system 500 positioned between the first positioner 106 (or a second positioner 108) and the scan lens 112, so that when the beam of laser energy 116 is scanned (e.g., as diffracted by the first positioner 106 or reflected by the second positioner 108), the pivot point 134 is located at or near the entrance pupil 132 of the scan lens 112. As shown, the optical relay system 500 includes the zoom lens assembly 510 positioned between the first lens 502 and the second lens 506. The lenses of the first lens group 516 are separated by a distance A and the lenses of the second lens group 522 are separated by a distance B. In this embodiment, the distance, C, between the first lens group 516 and the second lens group 522 is fixed. The laser spot 532 with a diameter Do is shown below the first positioner 106 (e.g., at the image plane of the first positioner 106). The laser spot 532′ (e.g., as amplified by the optical relay system 500) with a diameter of D₁ is shown below the entrance pupil 132. In this positional state, the magnification set point of the optical relay system 500 is set such that the laser spot 532 undergoes lateral magnification from a diameter of D₀ (e.g., 30 μm) by a factor of M (e.g., 1.414) to a diameter of D₁=1.414*D₀=42 μm.

FIG. 13B shows an example of a change in the positional state shown in FIG. 13A when the magnification set point of the optical relay system 500 has been adjusted by moving the zoom lens assembly 510 toward the first lens 502 (e.g., by actuation of the first positioner 524 shown in FIG. 12). In this example, the magnification set point M is changed from 1.414 to 1.50, resulting in the diameter D₀ (e.g., 30 μm) of the laser spot 532 undergoing lateral magnification to D₂=1.50*D₀=45 μm. This change in the magnification set point results in a change in longitudinal magnification of image plane of the first positioner 106, causing mislocation of the pivot point 134 from the entrance pupil 132.

FIG. 13C shows an example of a change in the positional state of the optical relay system 500 shown in FIG. 13B. As shown, the spacing A of the first lens group 516 (e.g., by actuating the second positioner 526 shown in FIG. 12) is adjusted to a spacing of A′, and the spacing B of the second lens group 522 (e.g., by actuation of the third positioner 528 shown in FIG. 12), is adjusted to a spacing of B′. These adjustments result in a change of the longitudinal magnification to relocate the pivot point 134 at the entrance pupil 132, while maintaining the lateral magnification of the laser spot 532″ at 45 μm.

### III. CONCLUSION

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

1. A system, comprising:
a first positioner configured to deflect a beam of laser energy about a pivot point;
a scan lens movable relative to the first positioner; and
an optical relay system configured to relay the pivot point to the scan lens in correspondence with movement of the scan lens.

2. The system of claim 1, wherein the first positioner is at least one selected from the group consisting of an AOD system and a galvanometer mirror system.

3. The system of claim 1, wherein the scan lens is movable relative to the optical relay system.

4. The system of claim 1, wherein the optical relay system is movable relative to at least one selected from the scan lens and the first positioner.

5. The system of claim 1, wherein the optical relay system includes:
an optical input;
a first reflector having a first reflective surface, wherein the first reflector is arranged to receive the beam of laser energy propagating from the first positioner;
an optical output; and
a second reflector having a second reflective surface opposing the first reflective surface, wherein the first reflective surface and the second reflective surface are arranged and configured to relay the beam of laser energy received at the first reflector from the optical input to the optical output.

6. The system of claim 5, wherein the optical relay system further includes:
a first lens arranged and configured to focus the beam of laser energy within the optical relay system; and
a second lens arranged and configured to focus the beam of laser energy exiting the optical relay system.
wherein the first lens and the second lens are configured to magnify the beam of laser energy.

7. The system of claim 6, wherein the first lens is configured to focus the beam of laser energy at a point that is separated from the first reflective surface and the second reflective surface.

8. The system of claim 5, further comprising a stage coupled to the optical relay system, wherein the stage is operative change a position of the optical relay system relative to at least one selected from the scan lens and the first positioner.

9. (canceled)

10. The system of claim 1, further comprising a second positioner arranged between the optical relay system and the scan lens.

11. The system of claim 10, wherein the second positioner is at least one selected from the group consisting of a galvanometer, an AOD system, a fast steering mirror, and a rotating polygon mirror.

12. An optical relay system, comprising:
an optical input;
a first reflector having a first reflective surface wherein the first reflector is arranged to receive the beam of laser energy propagating from the first positioner;
an optical output; and
a second reflector having a second reflective surface opposing the first reflective surface, wherein the first and second reflective surfaces are arranged and configured to relay the beam of laser energy received at the first reflector from the optical input to the optical output.

13. The optical relay system of claim 12, wherein the first reflective surface and the second reflective surface are substantially parallel to one another.

14. The optical relay system of claim 12, wherein the first reflective surface and the second reflective surface are not parallel to one another.

15. The optical relay system of claim 12, wherein the optical relay system further includes:
a first lens mounted at the optical input; and
a second lens mounted at the optical output.

16. (canceled)

17. (canceled)

18. (canceled)

19. (canceled)

20. An optical relay system, comprising:
a first lens;
a second lens;
a zoom lens assembly arranged between the first lens and the second lens, wherein the zoom lens assembly includes a first lens group and a second lens group, and wherein each of the first lens group and the second lens group includes a plurality of lenses.

21. The optical relay system of claim 20, wherein the zoom lens assembly is movable relative to at least one of the first lens and the second lens.

22. The optical relay system of claim 21, wherein the zoom lens assembly is mounted on a first positioner.

23. The optical relay system of claim 22, wherein the first positioner is a motion stage.

24. The optical relay system of claim 20 wherein at least one of the first lens and the second lens are selected from the group consisting of positive lenses, planar-convex lenses, bi-convex lenses, and positive meniscus lenses.

25. The optical relay system of claim 20, wherein the first lens group and the second lens group are telephoto doublets arranged symmetrically with respect to a transverse centerline of the zoom lens assembly.

26. The optical relay system of claim 20, wherein a distance between at least two lenses of the first lens group and a distance between at least two lenses of the second lens group is fixed.

27. The optical relay system of claim 20, wherein a distance between at least two lenses of the first lens group and a distance between at least two lenses of the second lens group is variable.

28. The optical relay system of claim 27 wherein the first lens group is mounted on a second positioner configured to adjust the distance between at least two lenses of the first lens group.

29. The optical relay system of claim 28, wherein the second positioner is a motion stage.

30. The optical relay system of claim 27 wherein the second lens group is mounted on a third positioner configured to adjust the distance between at least two lenses of the second lens group.

31. The optical relay system of claim 30, wherein the third positioner is a motion stage.
